(19) United States
(12) Patent Application Publication
(10) Pub. No.: US 2024/0340777 A1
(43) Pub. Date: Oct. 10, 2024

(54) METHOD AND UE FOR MANAGING SATELLITE COVERAGE AVAILABILITY INFORMATION IN TELECOMMUNICATION NETWORK

(71) Applicant: SAMSUNG ELECTRONICS CO., LTD., Suwon-si (KR)

(72) Inventors: Lalith KUMAR, Bangalore (IN); Aman AGARWAL, Bangalore (IN); Sidhant JAIN, Bangalore (IN); Mahmoud WATFA, Staines (GB)

(21) Appl. No.: 18/628,627

(22) Filed: Apr. 5, 2024

(30) Foreign Application Priority Data
Apr. 6, 2023 (IN) 202341026132
Mar. 20, 2024 (IN) 202341026132

(51) Int. Cl. H04W 48/16; H04B 7/185; H04W 84/04

(52) U.S. Cl. CPC H04W 48/16; H04B 7/18513; H04W 84/042

(57) ABSTRACT

The present disclosure relates to a 5G communication system or a 6G communication system for supporting higher data rates beyond a 4G communication system such as long term evolution (LTE). An embodiment herein is to provide a method performed by a user equipment (UE) in a wireless communication system, the method comprising: receiving satellite coverage availability information, identifying, based on the satellite coverage availability information, a coverage for a satellite communication at a location and a time is available or not, identifying, information on at least one or more public land mobile networks (PLMNs) for the UE at a present location of the UE, and performing, a communication based on the information on the at least one or more PLMNs.

### CROSS-REFERENCE TO RELATED APPLICATIONS

This application is based on and claims priority under 35 U.S.C. § 119 to Indian Partial patent application Ser. No. 20/234,1026132 filed on Apr. 6, 2023 and Indian Complete patent application Ser. No. 20/234,1026132 filed on Mar. 20, 2024, in the Indian Intellectual Property Office, the disclosures of which are incorporated by reference herein in their entirety.

### BACKGROUND

### 1. Fields

The present disclosure relates to a telecommunication network, and more specifically related to a method and a user equipment (UE) to manage the satellite coverage information in the telecommunication network.

### 2. DESCRIPTION OF RELATED ART

Considering the development of wireless communication from generation to generation, the technologies have been developed mainly for services targeting humans, such as voice calls, multimedia services, and data services. Following the commercialization of 5th generation (5G) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6th generation) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bit per second (bps) and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz (THz) band (for example, 95 gigahertz (GHz) to 3 THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, Radio Frequency (RF) elements, antennas, novel waveforms having a better coverage than Orthogonal Frequency Division Multiplexing (OFDM), beamforming and massive Multiple-input Multiple-Output (MIMO), Full Dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, Orbital Angular Momentum (OAM), and Reconfigurable Intelligent Surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, High-Altitude Platform Stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; an use of Artificial Intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as Mobile Edge Computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended Reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

In general, a 5G system with satellite access, the following requirements apply: the 5G system may support service continuity between NR terrestrial access network and NR satellite access networks owned by the same operator or owned by 2 different operators having an agreement. The NTN and TN could either operate in two different frequency bands (e.g., FR1 vs FR2), or in same frequency band (e.g., FRI or FR2). The terms satellite 3GPP access, satellite access, satellite access network, NR satellite access network, satellite NG-RAN access technology and NR satellite access have been interchangeably used and have the same meaning.

When satellite-1 is providing service in an area, then if that satellite goes away from the same area some other satellite may come and serve the same area. But this may not be possible all the times thus the time duration in which a first satellite moves and creates a gap till next satellite comes to provide service is called as discontinuous coverage period. The UE is expected to calculate this discontinues coverage period, how exactly this information is calculated by UE using certain parameters which are important to determine the duration is discussed in this embodiment.

The above information is presented as background information only to help the reader to understand the present disclosure. Applicants have made no determination and make no assertion as to whether any of the above might be applicable as prior art with regard to the present application.

The principal object of the embodiments herein is to provide a method and a UE to manage satellite coverage information in a telecommunication network. The satellite coverage availability information is used by the UE to determine the discontinuous coverage period and perform operations related to discontinuous coverage. The provided method provides parameters which may be provided in the satellite coverage availability information (SCAI) for accurate determination of discontinuous coverage by the UE.

Another objective of the embodiment herein is to provide coverage information in an area so as the UE knows when satellite coverage may be available in an area and when satellite coverage may not be available in an area by the satellite/network.

Another objective of the embodiment herein is to determine whether a coverage for a specific satellite RAT type is available or not available for a location and a time based on the received satellite coverage availability information.

Another objective of the embodiment herein is to determine that a PLMN is allowed to operate in the location based on the received satellite coverage availability information in response to determining that the coverage is available in the location.

Another objective of the embodiment herein is to compute an unavailability information to support a discontinuous coverage operation in response to determining that the PLMN is allowed to operate in the location.

### SUMMARY

Accordingly the embodiment herein is to provide a method performed by a user equipment (UE) in a wireless communication system, the method comprising: receiving satellite coverage availability information, identifying, based on the satellite coverage availability information, a coverage for a satellite communication at a location and a time is available or not, identifying, information on at least one or more public land mobile networks (PLMNs) for the UE at a present location of the UE, and performing, a communication based on the information on the at least one or more PLMNs.

Accordingly the embodiment herein is to provide a method performed by a network entity in a wireless communication system, the method comprising: transmitting, to a user equipment (UE), satellite coverage availability information, identifying, based on the satellite coverage availability information, a coverage for a satellite communication at a location and a time is available or not, identifying, information on at least one or more public land mobile networks (PLMNs) for the UE at a present location of the UE, and performing, a communication based on the information on the at least one or more PLMNs.

Accordingly the embodiment herein is to provide a user equipment (UE) in a wireless communication system, the method comprising: a transceiver; and a controller coupled to the transceiver; the controller is configured to: receive satellite coverage availability information, identify, based on the satellite coverage availability information, a coverage for a satellite communication at a location and a time is available or not, identify, information on at least one or more public land mobile networks (PLMNs) for the UE at a present location of the UE, and perform, a communication based on the information on the at least one or more PLMNs.

Accordingly the embodiment herein is to provide a network entity in a wireless communication system, the method comprising: a transceiver, and a controller coupled to the transceiver; the controller is configured to: transmit, to a user equipment (UE), satellite coverage availability information, identify, based on the satellite coverage availability information, a coverage for a satellite communication at a location and a time is available or not, identify, information on at least one or more public land mobile networks (PLMNs) for the UE at a present location of the UE, and perform, a communication based on the information on the at least one or more PLMNs.

Accordingly the embodiment herein is to provide a network entity in a wireless communication system, the method comprising: a transceiver; and a controller coupled to the transceiver; the controller is configured to: transmit, to a user equipment (UE), satellite coverage availability information; identify, based on the satellite coverage availability information, a coverage for a satellite communication at a location and a time is available or not; identify, information on at least one or more public land mobile networks (PLMNs) for the UE at a present location of the UE; and perform, a communication based on the information on the at least one or more PLMNs.

Accordingly, the embodiment herein is to provide a UE for managing a satellite coverage availability information in a telecommunication network. The UE includes a satellite coverage availability information controller coupled with a memory and a processor. The satellite coverage availability information controller is configured to receive the satellite coverage availability information from an entity in the telecommunication network. Further, the satellite coverage availability information controller is configured to determine whether a coverage for a specific satellite RAT type is available or not available for a location and a time based on the received satellite coverage availability information. Further, the satellite coverage availability information controller is configured to determine that a PLMN is allowed to operate in the location based on the received satellite coverage availability information in response to determining that the coverage is available in the location. Further, the satellite coverage availability information controller is configured to compute an unavailability information to support a discontinuous coverage operation in response to determining that the PLMN is allowed to operate in the location.

In an embodiment, the satellite coverage availability information is received from a network entity via at least one of a protocol data unit (PDU) session or a short message service (SMS).

In an embodiment, the satellite coverage availability information includes a cause indicating that a public land mobile network (PLMN) is not allowed to operate at a present location of the UE.

In an embodiment, the satellite coverage availability information includes a subset area information including at least one of allowed PLMN IDs or not allowed PLMN IDs at a present location of the UE.

In an embodiment, the network entity comprises at least one of a satellite coverage availability function (SCAF) entity, an access and mobility management function (AMF) entity or an external server.

In an embodiment, the discontinuous coverage operation reports the unavailability information to the entity (e.g., AMF or MME) and use for power saving in the UE.

In an embodiment, the unavailability information includes at least one of: a type of unavailability, an unavailability period duration, and a start of the unavailability period.

In an embodiment, the PLMN is not allowed to operate in the location and the time based on at least one of: a regulatory reason, an operator agreement and a local policy.

In an embodiment, the satellite coverage availability information is received from the entity via at least one of a Protocol Data Unit (PDU) session and a Short Message Service (SMS), wherein the entity is at least one of: a network apparatus and an external server.

In an embodiment, the network apparatus is at least one of: SCAF entity and an AMF entity.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the scope thereof, and the embodiments herein include all such modifications.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF DRAWINGS

For a more complete understanding of the present disclosure and its advantages, reference is now made to the following description taken in conjunction with the accompanying drawings, in which like reference numerals represent like parts:

The method and the UE are illustrated in the accompanying drawings, throughout which like reference letters indicate corresponding parts in the various figures. The embodiments herein will be better understood from the following description with reference to the drawings, in which:

FIG. 1 illustrates a service link and feeder link according to embodiments of the present disclosure;

FIG. 2 illustrates a UE fetching the coverage information from a network server in a telecommunication network according to embodiments of the present disclosure;

FIG. 3 illustrates steps for AMF to deliver coverage information to UE in the telecommunication network, according to embodiments of the present disclosure;

FIG. 4 illustrates a UE according to the embodiments of the present disclosure;

FIG. 5 illustrates a flowchart of a method for managing satellite coverage availability information in the telecommunication network according to the embodiments of the present disclosure;

FIG. 6 illustrates an internal configuration of a network entity according to the embodiments of the present disclosure; and

FIG. 7 illustrates an internal structure of a terminal according to the embodiments of the present disclosure.

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the disclosure. Furthermore, the one or more elements may have been represented in the drawing by conventional symbols, and the drawings may show only those specific details that are pertinent to the understanding the embodiments of the disclosure so as not to obscure the drawing with details that will be readily apparent to those of ordinary skill in the art having benefit of the description herein.

### DETAILED DESCRIPTION

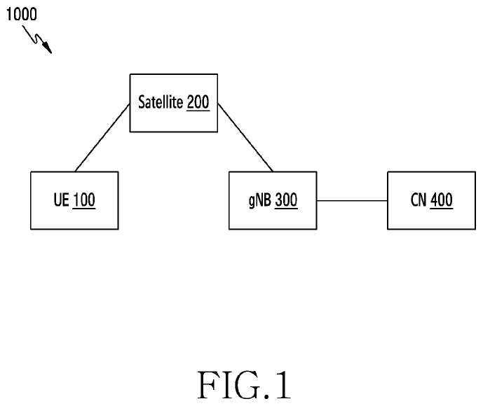

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

The below abbreviations used in the patent description:
1. UE-User Equipment
2. DL-Downlink
3. NR-New radio
4. NG-Next generation
5. 5G-5th generation
6. RA-Radio Access
7. RAN-Radio access network
8. E-UTRAN-Evolved Universal Mobile Telecommunications RAN
9. LTE-Long-Term Evolution
10. NAS-Non-Access-Stratum
11. AMF-Access and Mobility Management Function
12. 3GPP-Third Generation Partnership Project
13. 4G-GUTI-4G-Globally Unique Temporary Identifier
14. 5GC-5G Core
15. 5 GCN-5G Core Network
16. 5G-GUTI-5G-Globally Unique Temporary Identifier
17. 5 GMM-5G Mobility Management
18. 5GS-5G System
19. 5 GSM-5GS Session Management
20. AMBR-Aggregate Maximum Bit Rate
21. AMF-Access and Mobility Management Function
22. AS-Access Stratum
23. CAG-Closed access group
24. CAG ID-Closed Access Group Identifier
25. DC-Discontinuous Coverage
26. DisCo-Discontinuous Coverage
27. DRX-Discontinuous Reception
28. DU-Distributed Unit
29. eDRX-Extended Discontinuous Reception
30. EHPLMN-Equivalent Home Public Land Mobile Network
31. EMM-EUTRA Mobility Management
32. eNB-Evolved Node-B
33. EPLMN-Equivalent Public Land Mobile Network
34. EPS-Evolved Packet System
35. eSIM-embedded Subscriber Identity Module
36. E-UTRA-Evolved Universal Mobile Telecommunication Access
37. EUTRAN-Evolved Universal Mobile Telecommunication Access Network
38. GEO-Geostationary Orbit
39. gNB-Next generation Node-B
40. GPRS-General Packet Radio Service
41. GPS-Global Positioning System
42. GSM-Global System for Mobile Communication
43. HPLMN-Home Public Land Mobile Network
44. LEO-Low Earth Orbit
45. MCC-Mobile Country Code
46. ME-Mobile Equipment
47. MEC-Multi-Access Edge Computing
48. MEO-Medium Earth Orbit
49. MME-Mobility Management Entity
50. MNC-Mobile Network Code
51. MS-Mobile Station. The present document makes no distinction between MS and UE.
52. NAS-Non-Access Stratum
53. NB-S1 Mode-Narrow Band with S1 Interface
54. NG-RAN-Next Generation Radio Access Network
55. NTN-Non Terrestrial Networks
56. NW-Network
57. PDU-Packet Data Unit
58. PLMN ID-Public Land Mobile Network Identity
59. RAT-Radio Access Technology
60. RPLMN-Registered Public Land Mobile Network
61. RU-Registration Update
62. SAT-Satellite
63. SIM-Subscriber Identity Module
64. SNPN-Standalone Non-Public Networks
65. SUCI-Subscription Concealed Identifier
66. SW-Software
67. TAC-Tracking Area Code
68. TAI-Tracking Area Identity
69. TAU-Tracking Area Update
70. TER-Terrestrial
71. TN-Terrestrial Networks
72. UCU-UE Configuration Update
73. UDM-Unified Data Management Function
74. UE-User Equipment
75. UL-Uplink
76. ULI-User Location Information
77. USIM-Universal Subscriber Identification Module
78. Uu-The radio interface between the UE and the Node B
79. VPLMN-Visited Public Land Mobile Network

The example list of NAS messages (and not limited to):
a) REGISTRATION REQUEST message;
b) DEREGISTRATION REQUEST message;
c) SERVICE REQUEST message; and
d) CONTROL PLANE SERVICE REQUEST.
e) IDENTITY REQUEST
f) AUTHENTICATION REQUEST;
g) AUTHENTICATION RESULT;
h) AUTHENTICATION REJECT;
i) REGISTRATION REJECT
j) REGISTRATION ACCEPT
k) DEREGISTRATION ACCEPT
l) SERVICE REJECT
m) SERVICE ACCEPT
n) UE CONFIGURATION UPDATE command
o) UE PARAMETERS UPDATE command

The term 5 GMM sublayer states in the embodiment are at least one of the below:
1) 5 GMM-NULL
2) 5 GMM-DEREGISTERED
   a) 5 GMM-DEREGISTERED.NORMAL-SERVICE
   b) 5 GMM-DEREGISTERED.LIMITED-SERVICE
   c) 5 GMM-DEREGISTERED.ATTEMPTING-REGISTRATION
   d) 5 GMM-DEREGISTERED.PLMN-SEARCH
   e) 5 GMM-DEREGISTERED.NO-SUPI
   f) 5 GMM-DEREGISTERED.NO-CELL-AVAILABLE
   g) 5 GMM-DEREGISTERED.eCALL-INACTIVE
   h) 5 GMM-DEREGISTERED.INITIAL-REGISTRATION-NEEDED
3) 5 GMM-REGISTERED-INITIATED
4) 5 GMM-REGISTERED
   a) 5 GMM-REGISTERED.NORMAL-SERVICE
   b) 5 GMM-REGISTERED.NON-ALLOWED-SERVICE
   c) 5 GMM-REGISTERED.ATTEMPTING-REGISTRATION-UPDATE
   d) 5 GMM-REGISTERED.LIMITED-SERVICE
   e) 5 GMM-REGISTERED.PLMN-SEARCH
   f) 5 GMM-REGISTERED.NO-CELL-AVAILABLE
   g) 5 GMM-REGISTERED.UPDATE-NEEDED
5) 5 GMM-DEREGISTERED-INITIATED
6) 5 GMM-SERVICE-REQUEST-INITIATED

In one embodiment, the term EMM sublayer states are at least one of the below:
1) EMM-NULL
2) EMM-DEREGISTERED
   a) EMM-DEREGISTERED.NORMAL-SERVICE
   b) EMM-DEREGISTERED.LIMITED-SERVICE
   c) EMM-DEREGISTERED.ATTEMPTING-TO-ATTACH
   d) EMM-DEREGISTERED.PLMN-SEARCH
   e) EMM-DEREGISTERED.NO-IMSI
   f) EMM-DEREGISTERED.ATTACH-NEEDED
   g) EMM-DEREGISTERED.NO-CELL-AVAILABLE
   h) EMM-DEREGISTERED.eCALL-INACTIVE
3) EMM-REGISTERED-INITIATED
4) EMM-REGISTERED
   a) EMM-REGISTERED.NORMAL-SERVICE
   b) EMM-REGISTERED.ATTEMPTING-TO-UPDATE
   c) EMM-REGISTERED.LIMITED-SERVICE
   d) EMM-REGISTERED.PLMN-SEARCH
   e) EMM-REGISTERED.UPDATE-NEEDED
   f) EMM-REGISTERED.NO-CELL-AVAILABLE
   g) EMM-REGISTERED.ATTEMPTING-TO-UPDATE-MM
   h) EMM-REGISTERED.IMSI-DETACH-INITIATED
5) EMM-DEREGISTERED-INITIATED
6) EMM-TRACKING-AREA-UPDATING-INITIATED
7) EMM-SERVICE-REQUEST-INITIATED

The term RAT as defined in the embodiment can be one of the following:
a) NG-RAN
b) 5G, 4G, 3G, 2G
c) EPS, 5GS
d) NR
e) NR in unlicensed bands
f) NR (LEO) satellite access
g) NR (MEO) satellite access
h) NR (GEO) satellite access
i) NR (OTHERSAT) satellite access
j) NR RedCap
k) E-UTRA
1) E-UTRA in unlicensed bands
m) NB-IoT
n) WB-IoT
0) LTE-M

5GS registration type are:
a) initial registration,
b) mobility registration updating,
c) periodic registration updating,
d) emergency registration,
e) SNPN onboarding registration,
f) “disaster roaming initial registration”; or
g) “disaster roaming mobility registration updating.”

The below definition used in the patent description:

PLMN selection as per 23.122 without RPLMN: the MS selects and attempts registration on any PLMN/access technology combinations, if available and allowable, in the following order:
a) either the HPLMN (if the EHPLMN list is not present or is empty) or the highest priority EHPLMN that is available (if the EHPLMN list is present);
b) each PLMN/access technology combination in the “User Controlled PLMN Selector with Access Technology” data file in the SIM (in priority order);
c) each PLMN/access technology combination in the “Operator Controlled PLMN Selector with Access Technology” data file in the SIM (in priority order) or stored in the ME (in priority order);
d) other PLMN/access technology combinations with received high quality signal in random order;
e) other PLMN/access technology combinations in order of decreasing signal quality.

PLMN selection as per 23.122 with RPLMN: The MS selects and attempts registration on any PLMN/access technology combinations, if available and allowable, in the following order:
a) either the RPLMN or the Last registered PLMN;
b) either the HPLMN (if the EHPLMN list is not present or is empty) or the highest priority EHPLMN that is available (if the EHPLMN list is present);
c) each PLMN/access technology combination in the “User Controlled PLMN Selector with Access Technology” data file in the SIM (in priority order);
d) each PLMN/access technology combination in the “Operator Controlled PLMN Selector with Access Technology” data file in the SIM (in priority order) or stored in the ME (in priority order);
e) other PLMN/access technology combinations with received high quality signal in random order; and other PLMN/access technology combinations in order of decreasing signal quality.

Visited PLMN (VPLMN): this is a PLMN different from the HPLMN (if the EHPLMN list is not present or is empty) or different from an EHPLMN (if the EHPLMN list is present).

Allowable PLMN: in the case of an MS operating in MS operation mode A or B, this is a PLMN which is not in the list of “forbidden PLMNs” in the MS. In the case of an MS operating in MS operation mode C or an MS not supporting A/Gb mode and not supporting Iu mode, this is a PLMN which is not in the list of “forbidden PLMNs” and not in the list of “forbidden PLMNs for GPRS service” in the MS.

Available PLMN: PLMN(s) in the given area which is/are broadcasting capability to provide wireless communication services to the UE.

Camped on a cell: the MS (ME if there is no SIM) has completed the cell selection/reselection process and has chosen a cell from which the MS plans to receive all available services. Note that the services may be limited, and that the PLMN or the SNPN may not be aware of the existence of the MS (ME) within the chosen cell.

EHPLMN: any of the PLMN entries contained in the Equivalent HPLMN list.

Equivalent HPLMN list: to allow provision for multiple HPLMN codes, PLMN codes that are present within the list may replace the HPLMN code derived from the IMSI for PLMN selection purposes. The list is stored on the USIM and is known as the EHPLMN list. The EHPLMN list may also contain the HPLMN code derived from the IMSI. If the HPLMN code derived from the IMSI is not present in the EHPLMN list then the code may be treated as a Visited PLMN for PLMN selection purposes.

Home PLMN: this is a PLMN where the MCC and MNC of the PLMN identity match the MCC and MNC of the IMSI.

Registered PLMN (RPLMN): this is the PLMN on which certain LR (location registration which is also called as registration procedure) outcomes have occurred. In a shared network the RPLMN is the PLMN defined by the PLMN identity of the CN operator that has accepted the LR.

Registration: this is the process of camping on a cell of the PLMN or the SNPN and doing any necessary LRs.

UPLMN: PLMN/access technology combination in the “user controlled PLMN selector with access technology” data file in the SIM (in priority order).

OPLMN: PLMN/access technology combination in the “operator controlled PLMN selector with access technology” data file in the SIM (in priority order) or stored in the ME (in priority order).

Satellite: an artificial body placed in orbit round the earth or moon or another planet in order to collect information or for communication.

Satellite constellation: group of satellites: placed in orbit round the earth or moon or another planet in order to collect information or for communication.

Service user: an individual who has received a priority level assignment from a regional/national authority (i.e., an agency authorised to issue priority assignments) and has a subscription to a mobile network operator.

The terms UE and MS are used interchangeably in the embodiment and have the same meaning.

Embodiments herein disclose a method for managing satellite coverage availability information in a telecommunication network. The method includes receiving, by a UE, the satellite coverage availability information from an entity in the telecommunication network. Further, the method includes determining, by the UE, whether a coverage for a specific satellite RAT type is available or not available for a location and a time based on the received satellite coverage availability information. Further, the method includes determining, by the UE, that a PLMN is allowed to operate in the location based on the received satellite coverage availability information in response to determining that the coverage is available in the location. Further, the method includes computing, by the UE, an unavailability information to support a discontinuous coverage operation in response to determining that the PLMN is allowed to operate in the location.

In an embodiment, the satellite/network provides coverage information in an area so as the UE knows when satellite coverage may be available in an area and when satellite coverage may not be available in an area. The UE connected to NEO, LEO or GEO satellite for satellite access receives coverage information from the satellite, wherein the UE uses coverage information (after calculating the discontinuous coverage period) to set power saving parameters at UE for e.g., to help to determine when to return to coverage after a discontinuous coverage period, whether to listen to paging in eDRX, not to initiate any NAS signalling (including service request for MO data) within the discontinuous coverage period in case of any UL signalling/data request or the UE may deactivate its access stratum functions for NR satellite access in order to optimise power consumption until coverage returns, search neighbour cells when the serving satellite is about to leave coverage, not listen to paging when satellite coverage may not be available etc. The coverage information provided by the satellite may be per UE or be generic information, applicable to all UEs in an area.

The methods, issues or solutions disclosed in the embodiment are explained using NR satellite access or satellite NG-RAN Access Technology as an example and is not restricted or limited to NR satellite access only. However, the solutions provided in the embodiment are also applicable for satellite E-UTRAN access technology, narrow band (NB)-S1 mode or wide band (WB)-S1 mode via satellite E-UTRAN access and/or NB-IoT (NarrowBand Internet Of Things) or WB-IoT (WideBand Internet Of Things) satellite access/architecture.

The solutions which are defined for NR (5GC) are also applicable to legacy RATs like E-UTRA/LTE, the corresponding CN entities needs to be replaced by LTE entities for e.g., AMF with MME, g-nodeB with e-nodeB, UDM with HSS etc. But principles of the solution remain same.

The solutions explained in the embodiment are applicable to any (but not limited to) of the RAT(s) as defined in the embodiment. The network used in the embodiment is explained using any 5G core network function for e.g., AMF entity. However, the network could be any 5G/EUTRAN core network entities like AMF/SMF/MME/UPF or the network could be any 5G/EUTRAN RAN entity like eNodeB (eNB) or gNodeB (gNB) or NG-RAN etc.

The messages used or indicated in the embodiment are shown as an example. The messages could be any signalling messages between UE and the network Functions/Entities or between different network functions/entities.

The term area/location/geographical area are used in the embodiment may refer to any of cell/cell ID, TAC/TAI, PLMN, MCC/MNC, Latitude/longitude, CAG cell or any geographical location/coordinate.

The terms discontinuous coverage period, unavailability information, unavailability period duration are used interchangeably and have same meaning. This includes at least one of unavailability period duration and/or the start of unavailability period and the unavailability type (which indicates type of unavailability).

The terms camp and register are used interchangeably and have the same meaning. The terms wait timer, DisCo wait timer, discontinuous coverage wait timer, random timer, random wait timer, DCW range, DCW timer are all used interchangeably and have the same meaning.

The cause names in the embodiment are for illustration purpose and they can have any name. The non access stratum (NAS) messages and access stratum (AS) messages described in the embodiment are only for illustration purpose they can be any NAS or AS messages as per defined protocol between UE and AMF/MME or UE and gNB (NG-RAN/any RAN node)/eNB.

In satellite communication, due to mobile nature of satellite, the satellite coverage in an area changes overtime with movement of satellites. A UE being served in an area by a satellite may at some later time not find the coverage in same area. Therefore, it is needed that the satellite/network provides coverage information in an area so as the UE knows when satellite coverage may be available in an area and when satellite coverage may not be available in an area.

The terms coverage information, satellite coverage availability information, and coverage availability information are used interchangeably and have the same meaning.

The UE connected to the NEO, LEO or GEO satellites for satellite access receives coverage information from the satellite.

The UE uses above information to set power saving parameters at UE, search neighbour cells when the serving satellite is about to leave coverage, not listen to paging when satellite coverage may not be available etc.

The coverage information provided by the satellite may be per UE or be generic information, applicable to all UEs in an area.

The cause #78 is given to a UE to prevent repeated attempts to obtain service on a PLMN through satellite NG-RAN access technology, when the MS or the UE receives an integrity protected reject message with cause value #78 “PLMNs not allowed to operate at the present UE location” from a satellite NG-RAN cell, the UE or the MS maintains a list of “PLMNs not allowed to operate at the present UE location” in which the UE or the MS stores the PLMN ID of the rejecting PLMN, the current geographical location and a timer. An entry in the list is deleted if the timer associated to the entry expires or the UE successfully registers to the PLMN stored in the entry.

If the UE's initial registration request is via a satellite NG-RAN cell and the network using the user location information provided by the NG-RAN, is able to determine that the UE is in a location where the network is not allowed to operate, the network may set the 5 GMM cause value in the REGISTRATION REJECT message to #78 “PLMN not allowed to operate at the present UE location.”

The 5 GMM cause IE is set to the 5 GMM cause #78 “PLMN not allowed to operate at the present UE location,” the UE passes to the 5 GSM sublayer an indication that the 5 GSM message was not forwarded because the UE is registered to a PLMN via a satellite NG-RAN cell that is not allowed to operate at the present UE location along with the 5 GSM message from the payload container IE of the DL NAS TRANSPORT message.

If the service request is via a satellite NG-RAN cell, and the network determines that the UE is in a location where the network is not allowed to operate, the network may set the 5 GMM cause value in the SERVICE REJECT message to #78 “PLMN not allowed to operate at the present UE location.”

Lower bound timer value: the AMF entity may include the IE when the 5 GMM cause is set to #78 “PLMN not allowed to operate at the present UE location” in the reject message, to provide a minimum time value for an entry added to the list of “PLMNs not allowed to operate at the present UE location.”

For 3GPP satellite NG-RAN the UE may store a list of “PLMNs not allowed to operate at the present UE location.” Each entry includes: the PLMN identity of the PLMN which sent a message including 5 GMM cause value #78 “PLMN not allowed to operate at the present UE location” via satellite NG-RAN access technology; and the geographical location, if known by the UE, where 5 GMM cause value #78 was received on satellite NG-RAN access technology; and if the geographical location exists, a UE implementation specific distance value. The UE implementation specific distance value may not be set to a value smaller than the value indicated by the network, if any.

Before storing a new entry in the list, the UE may delete any existing entry with the same PLMN identity. Upon storing a new entry, the UE starts a timer instance associated with the entry with an implementation specific value that may not be set to a value smaller than the timer value indicated by the network, if any.

The UE is allowed to attempt to access a PLMN via satellite NG-RAN access technology which is part of the list of “PLMNs not allowed to operate at the present UE location” only if: the current UE location is known, a geographical location is stored for the entry of the PLMN, and the distance to the current UE location is larger than a UE implementation specific value; or the access is for emergency services.

The UE may set the 5GS update status to 5U3 ROAMING NOT ALLOWED (and may store) and may delete 5G-GUTI, last visited registered TAI, TAI list and ngKSI. Additionally, the UE may reset the registration attempt counter. The UE may store the PLMN identity and, if it is known, the current geographical location in the list of “PLMNs not allowed to operate at the present UE location” and may start a corresponding timer instance. The UE may enter state 5 GMM-DEREGISTERED.PLMN-SEARCH and perform a PLMN selection according to 3GPP TS 23.15.

If the message was received via 3GPP access and the UE is operating in single-registration mode, the UE may handle the EMM parameters EMM state, EPS update status, 4G-GUTI, TAI list, eKSI and attach attempt counter as specified in 3GPP TS 24.301 for the case when the EPS attach procedure is rejected with the EMM cause with the same value.

Referring now to the drawings and more particularly to FIGS. 1 through 6, where similar reference characters denote corresponding features consistently throughout the figures, there are shown preferred embodiments.

FIG. 1 illustrates a service link and feeder link according to embodiments of the present disclosure. The service link is a radio link between a satellite (200) and the UE (100), and a feeder link is a wireless link between an NTN gateway and the satellite (200).

Transparent payload: satellite deployments in NTN networks is designed to be implemented with transparent payload, i.e., the messages/signals received from the UE (100) is transparently passed on to a gNB (300), and the messages/signals received from the gNB (300) is transparently passed on the UE (100).

Deployment options: satellite systems may be deployed with none or only some of the network functions (e.g., AMF entity, UPF entity etc.) present onboard the satellite (200). If the feeder link is not available, then the satellite (200) may not be able to provide any service, which involves any of the network functions on the ground (i.e., NFs not present on the satellite).

The coverage information/satellite coverage information is at least one of the below which can be provided by one NF (e.g., SCAF entity) to another NF (e.g., AMF) or AF entity (900) to NF (e.g., SCAF entity) or the AF entity (900) to the UE (100) or NF to UE (100) or any combination of NF/AF/UE the coverage information/satellite coverage information is shared:

Area: the area in which the satellite may be able to provide coverage.

Time slot: the time slot or duration in which the satellite may be able to provide the coverage in an area (This may be in form of start-time and end-time, or start-time and duration or duration from the time the message is received etc. or any other form).

Area not available: similar to area information in which the satellite coverage is available, satellite may also provide the information when the services is not available.

Time slot not available: similar to time slot information above, it may also give the time duration in which the satellite coverage is not available in an area.

Allowed services: the satellite may provide information about allowed services in an area (e.g., emergency services, disaster roaming service), in some areas only a specific set of services may be available.

Forbidden services: the network may also provide a list of services (e.g., emergency, voice, data, disaster roaming service), which the UE (100) is not allowed to access in an area. In an area a specific set of services may not be allowed.

Feeder link availability time slot: the feeder link availability time slot may be the case that satellite/NG-RAN is able to provide coverage (i.e., the service link) in a specific time slot but the feeder link availability time slot does not have a feeder link to base station. Thus UE (100) may be able to connect to the satellite, but satellite may not be able to connect to the base station/any other network function present on the ground when feeder link is not available, i.e., satellite may not be able to provide any service even when coverage is available. The information may be provided to the UE (100) in the coverage information so that UE (100) does not try to select/register or get any service during such period on the respective PLMN and RAT and it can calculate the feeder link unavailability period which can in-turn be used to calculate the discontinues coverage period or the period in which UE may not be served.

The Cause #78 subset area information: the network may combine the above information, with the information of area in which the satellite is not allowed to provide services (cause #78, PLMN not allowed to operate at the present UE (100) location) due to regulatory reasons or based on operator agreements or local policies. Thus, the network may provide subset area information also, which contains subset of the overall area in which a specific service is allowed or not allowed. List of services, PLMN IDs, and NIDs may be provided with subset information. i.e., network may also provide the area in which UE (100) is not allowed to operate or can calculate the area where the UE (100) is allowed to operate and indicate only that area to the UE (100).

The above information may be delivered per UE, or in general to all UEs available in an area. If the information is delivered per UE, the satellite/network function may consider UE's location and UE's mobility pattern, along with above information to determine the coverage information.

Alternatively, the coverage information may be provided by the network function/entity to the UE (100). The AMF entity (700) may determine the Cause #78 area (cause #78, PLMN not allowed to operate at the present UE (100) location) itself and apply the information to provide services to the UE (100).

Based on at least one of the above information, the UE (100) determines the discontinuous coverage period etc.

Examples of Availability information for the UE: satellite coverage information for UE1: (area a1, time t1, area a2, time t2, Allowed services: s1, s2, s3, feeder link unavailability time slot: tx, Cause #78 area subset: ax) satellite coverage information for UE2: (area a1, time t1, area a2, time t2, area a3, time t3, Allowed services: s1, s2, s3, s4, forbidden services: s5, feeder link unavailability time slot: tx, Cause #78 area subset: ax).

Example of Availability Information for the AMF: satellite coverage information for AMF: (area a1, time t1, area a2, time t2, Feeder Link unavailability time slot: tx, Cause #78 area subset: ax).

Some of the above information may be applicable for Availability information for the UE (100), but not applicable for the AMF entity (700). This may be due to UE subscription/capability etc.

The satellite coverage information for the AMF entity (700) (or any other network entity):

The satellite coverage availability information provisioned to the AMF entity (700) (or any other network entity) describes when and where satellite coverage is expected to be available in an area. The satellite coverage availability information for AMF entity (700) (or other NF) is not UE specific and can be applied by the AMF entity (700) (or any other network entity) for any UE (100) in the affected area.

The satellite coverage information for the AMF includes the information AMF entity (700) uses for communication with the UEs or other network functions, it may include only information which is applicable to all UEs in an area.

The AMF entity (700) may use the information to derive the satellite coverage information for the UE(s) combining the information with the UE's subscription and/or UE's mobility information etc. and delivers the information to the UE (100), either as a generic information applicable for all UEs, or on a per UE basis.

The satellite coverage information for the UE (100).

The satellite coverage availability information provisioned to the UE (100) describes when and where satellite coverage is expected to be available in an area where the UE (100) is operating or is expected to operate. The information includes information specific to the UE (100) (such as allowed services for that UE). The satellite coverage availability information for UE (100) is UE specific.

The satellite coverage information for the UE (100) is delivered by the AMF entity (700) to the UE (100), or UE (100) may fetch the information from an application server. Satellite coverage information for UE (100) may include information which is generic to all UEs in the AMF entity (700) (i.e., satellite coverage information for AMF), additionally the satellite coverage information may include the information specific to the UE (100).

The information specific to the UE (100) may include information derived on basis of UE subscription, UE mobility parameters etc.

For example, Area-1, Area-2 allowed for UE (100), Area-3 not allowed to operation in that location (i.e., if the UE (100) attempts registration from area-3 UE (100) may get reject cause #78). NF/AF may provide satellite coverage information for the UE (100) in at least one of the below combinations:

Only Area-1, Area-2 availability information is provided to the UE (100) along with other parameters discussed in the embodiment like time etc. The UE (100) assumes at Area-3 and the UE (100) may not get coverage from the respective satellite network.

Area-1, Area-2, Area-3 availability information is provided to the UE (100) along with other parameters discussed in the embodiment like time etc. Additionally, the UE (100) is indicated that in Area-3 and the UE (100) is not allowed to operate i.e., because PLMNs not allowed to operate at the present UE location, even if UE attempts registration in Area-3 UE may get the NAS message reject cause #78 optionally also includes other parameters discussed in the embodiment like applicable time slot for the PLMN-ID, NID etc. Satellite network can still serve and provide coverage information to other UEs in Area-3.

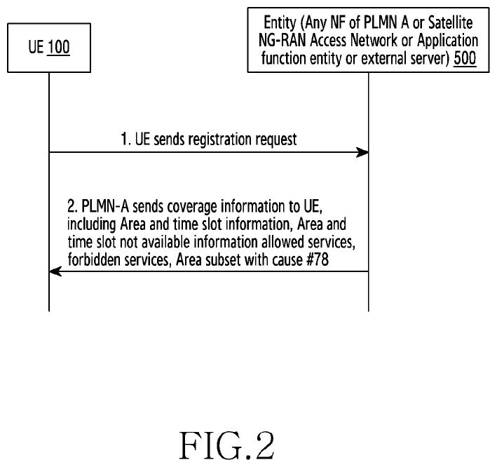

FIG. 2 illustrates a UE (100) fetching the coverage information from a network server in a telecommunication network (1000) according to embodiments of the present disclosure. The telecommunication network (1000) can be, for example, but not limited to a fourth generation (4G) network, a fifth generation (5G) network, an open radio access network (ORAN) or the like. At step 1, the UE (100) sends the registration request to the any NF of PLMN A or satellite NG-RAN access network or application function entity or external server. At step 2, the PLMN-A sends coverage information to the UE (100), including the area and time slot information, the area and time slot not available information allowed services, the forbidden services, and the area subset with cause #78.

In another embodiment, the UE (100) fetches the coverage information from a network server which stores the earlier discussed information. The UE (100) may use user plane connection, to fetch the information from the server. For user plane DNN+S-NSSAI or IP address is configured in the UE (100) by the network during registration/any other signalling. The UE (100) uses the end point information to fetch the coverage information from the server.

Alternatively, the satellite coverage information may be provided to UE (100) using SCAF entity (800) (or the information can be any other name) (similar to UCMF and UE radio capability management function). The SCAF entity (800) can be introduced in 5GC as shown in the architecture figure. The SCAF entity (800) stores all satellite coverage information (area, time, services available, area not available, time not available, feeder link unavailability period, forbidden services etc.) for a PLMN. The information may be provisioned in the SCAF entity (800) by the AF entity (900) directly or via the NEF entity (850).

The information may be stored on a per UE basis, or the information may be stored as a generic information applicable for all UEs. The SCAF entity (800) delivers the satellite coverage information to AMF, the AMF entity (700) then delivers the information to individual UEs. Alternatively, the AMF entity (700) may query satellite coverage information per UE (100) providing a UE identifier (such as GUTI) and provide the information to the UE (100).

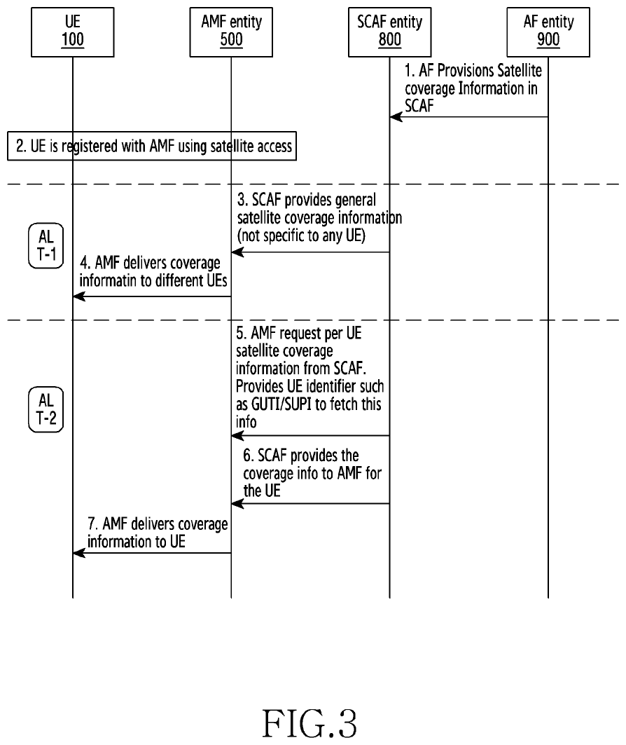

FIG. 3 illustrates steps for the AMF entity (700) to deliver coverage information to the UE (100) in the telecommunication network (1000) according to embodiments of the present disclosure.

At step 1, the AF entity (900) provisions the satellite coverage information in SCAF entity (800). It may be configured directly by the AF entity (900) or via the NEF entity (850). At step 2, the UE (100) is registered with the AMF entity (700) using the satellite access. At step 3, the SCAF entity (800) provides general satellite coverage information (not specific to any UE). This may be done periodically by the SCAF entity (800) or when there is any change in satellite coverage information. It may be also triggered on certain request by AMF entity (700). At step 4, the AMF entity (700) delivers coverage information to different UEs. The AMF entity (700) may deliver the generic information to each UE (100), or the AMF may use the mobility or other UE parameters like subscription etc. to determine per UE coverage information and deliver the information to the UE (100).

In another embodiment, at step 4, the AMF entity (700) may request per UE satellite coverage information from the SCAF entity (800) and Provide UE identifier such as GUTI/SUPI to fetch the information. At step 6, the SCAF entity (800) provides the UE (specific coverage info to the AMF entity (700) for the UE (100), if available, or the SCAF entity rejects the request with an appropriate cause. At step 7, the AMF entity (700) delivers coverage information to the UE (100). It may also combine the information with subscription etc. info before providing it to the UE (100).

In another embodiment, satellite coverage information may be stored in the SCAF entity (800) using SCID (satellite coverage information ID, the information can be any other name). Satellite coverage information may be stored in the SCAF entity (800), and the UE (100) and the AMF entity (700) may be provided the information with the corresponding SCID. For any communication between the UE (100) and AMF, and between the AMF entity (700) and the SCAF entity (800), only the SCID may be used. If the AF entity (900) updates the Satellite coverage Information in the SCAF entity (800) either directly or via the NEF entity (850), the SCAF entity (800) updates the satellite coverage information and associated SCID, upon which the updated satellite coverage information is provided/sent to AMF/UE along with the SCID to keep UE (100), the AMF entity (700) and the SCAF entity (800) in sync.

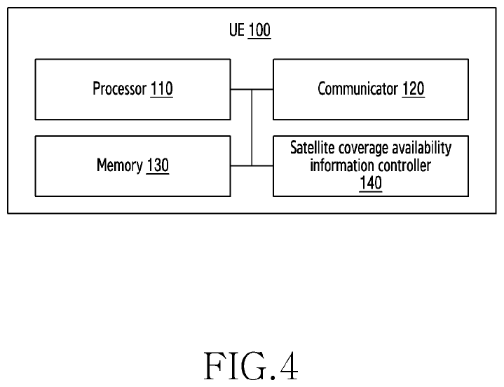

FIG. 4 illustrates a UE (100), according to the embodiments of the present disclosure. The UE (100) can be, for example, but not limited to a laptop, a smart phone, a desktop computer, a notebook, a device-to-device (D2D) device, a vehicle to everything (V2X) device, a foldable phone, a smart TV, a tablet, an immersive device, and an internet of things (IoT) device. In an embodiment, the UE (100) includes a processor (110), a communicator (120), a memory (130) and a satellite coverage availability information controller (140). The processor (110) is coupled with the communicator (120), the memory (130) and the satellite coverage availability information controller (140).

The satellite coverage availability information controller (140) receives the satellite coverage availability information from the entity (500) in the telecommunication network (1000). In an embodiment, the satellite coverage availability information is received from the entity (500) via at least one of the PDU session and the SMS. The entity (500) is at least one of: a network apparatus and an external server. In an embodiment, the network apparatus is at least one of: the SCAF entity (800) and the AMF entity (700).

Further, the satellite coverage availability information controller (140) determines whether the coverage for the specific satellite RAT type is available or not available for the location and the time based on the received satellite coverage availability information. Based on the received satellite coverage availability information and in response to determining that the coverage is available in the location, the satellite coverage availability information controller (140) determines that the PLMN is allowed to operate in the location. Further, the satellite coverage availability information controller (140) computes an unavailability information to support a discontinuous coverage operation in response to determining that the PLMN is allowed to operate in the location. In an embodiment, the discontinuous coverage operation reports the unavailability information to the entity (500) and use for power saving in the UE (100). In an embodiment, the unavailability information includes at least one of: the type of unavailability, the unavailability period duration, and the start of the unavailability period.

In an embodiment, the PLMN is not allowed to operate in the location and the time based on at least one of: the regulatory reason, the operator agreement and the local policy.

The satellite coverage availability information controller (140) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (110) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (110) may include multiple cores and is configured to execute the instructions stored in the memory (130).

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in random access memory (RAM) or cache).

In an embodiment, the communicator (120) includes an electronic circuit specific to a standard that enables wired or wireless communication. The communicator (120) is configured to communicate internally between internal hardware components of the UE (100) and with external devices via one or more networks.

Although the FIG. 4 shows various hardware components of the UE (100) but it is to be understood that other embodiments are not limited thereon. In other embodiments, the UE (100) may include less or more number of components. Further, the labels or names of the components are used only for illustrative purpose and does not limit the scope of the disclosure. One or more components can be combined together to perform same or substantially similar function in the UE (100).

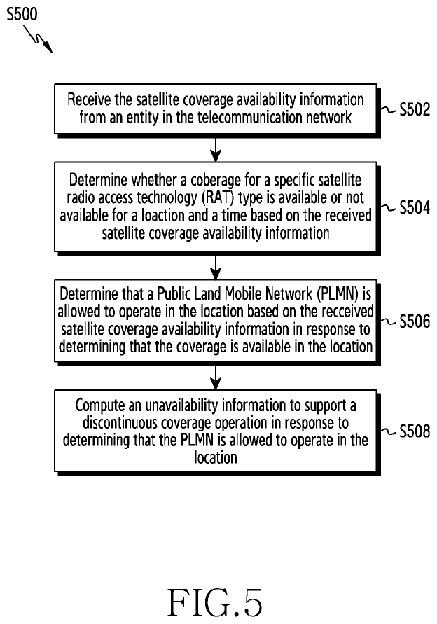

FIG. 5 illustrates a flowchart (S600) of a method for managing satellite coverage availability information in the telecommunication network (1000) according to the embodiments of the present disclosure. The operations (S502-S508) are handled by the satellite coverage availability information controller (140).

At S502, the method includes receiving the satellite coverage availability information from the entity (500) in the telecommunication network (1000). At S504, the method includes determining whether the coverage for the specific satellite RAT type is available or not available for the location and the time based on the received satellite coverage availability information. At S506, the method includes determining that the PLMN is allowed to operate in the location based on the received satellite coverage availability information in response to determining that the coverage is available in the location. At S508, the method includes computing an unavailability information to support the discontinuous coverage operation in response to determining that the PLMN is allowed to operate or not allowed to operate in the location.

The various actions, acts, blocks, steps, or the like in the flow chart (S500) may be performed in the order presented, in a different order or simultaneously. Further, in some embodiments, some of the actions, acts, blocks, steps, or the like may be omitted, added, modified, skipped, or the like without departing from the scope of the disclosure.

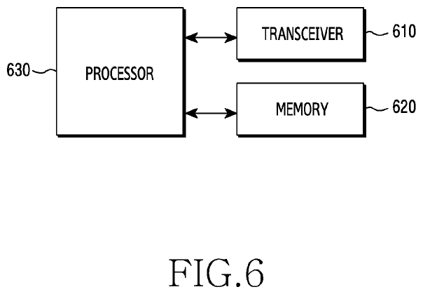

FIG. 6 illustrates an internal configuration of a network entity according to an embodiment of the present disclosure.

As shown in FIG. 6, the network entity according to an embodiment may include a transceiver 610, a memory 620, and a processor (or a controller) 630. The transceiver 610, the memory 620, and the processor 630 (or the controller) of the network entity may operate according to a communication method of the network entity described above. However, the components of the network entity are not limited thereto. For example, the network entity may include more or fewer components than those described above. In addition, the processor 630, the transceiver 610, and the memory 620 may be implemented as a single chip. Also, the processor 630 may include at least one processor. The network entity may include a network function (NF) such as an access and mobility management function (AMF), a session management function (SMF), a policy and charging function (PCF), a network exposure function (NEF), unified data management (UDM), a unified data repository (UDR), a user plane function (UPF) as described above. In addition, the network entity may include a base station and/or an external server.

The transceiver 610 collectively refers to a network entity receiver and a network entity transmitter, and may transmit/receive a signal to/from a terminal. The signal transmitted or received to or from the terminal may include control information and data. The transceiver 610 may include a RF transmitter for up-converting and amplifying a frequency of a transmitted signal, and a RF receiver for amplifying low-noise and down-converting a frequency of a received signal. However, this is only an example of the transceiver 610 and components of the transceiver 610 are not limited to the RF transmitter and the RF receiver.

Also, the transceiver 610 may receive and output, to the processor 630, a signal through a wireless channel, and transmit a signal output from the processor 630 through the wireless channel.

The memory 620 may store a program and data required for operations of the network entity. Also, the memory 620 may store control information or data included in a signal obtained by the network entity. The memory 620 may be a storage medium, such as read-only memory (ROM), random access memory (RAM), a hard disk, a CD-ROM, and a DVD, or a combination of storage media.

The processor 630 may control a series of processes such that the network entity operates as described above. For example, the transceiver 610 may receive a data signal and/or a control signal transmitted by the terminal, and the processor 630 may determine a result of receiving the signal transmitted by the terminal and/or the core network function.

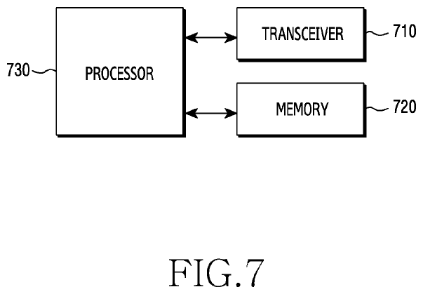

FIG. 7 illustrates an internal structure of a terminal according to an embodiment of the present disclosure.

As shown in FIG. 7, the terminal of the present disclosure may include a transceiver 710, a memory 720, and a processor (or a controller) 730. The transceiver 710, the memory 720, and the processor (or the controller) 730 of the terminal may operate according to a communication method of the terminal described above. However, the components of the terminal are not limited thereto. For example, the terminal may include more or fewer components than those described above. In addition, the processor 730, the transceiver 710, and the memory 720 may be implemented as a single chip. Also, the processor 730 may include at least one processor.

The transceiver 710 collectively refers to a terminal receiver and a terminal transmitter, and may transmit/receive a signal to/from a base station. The signal transmitted or received to or from the base station may include control information and data. In this regard, the transceiver 710 may include a RF transmitter for up-converting and amplifying a frequency of a transmitted signal, and a RF receiver for amplifying low-noise and down-converting a frequency of a received signal. However, this is only an example of the transceiver 710 and components of the transceiver 710 are not limited to the RF transmitter and the RF receiver.

Also, the transceiver 710 may receive and output, to the processor 730, a signal through a wireless channel, and transmit a signal output from the processor 730 through the wireless channel.

The memory 720 may store a program and data required for operations of the terminal. Also, the memory 720 may store control information or data included in a signal obtained by the terminal. The memory 720 may be a storage medium, such as ROM, RAM, a hard disk, a CD-ROM, and a DVD, or a combination of storage media.

The processor 730 may control a series of processes such that the terminal operates as described above. For example, the transceiver 710 may receive a data signal and/or a control signal, and the processor 730 may determine a result of receiving the signal transmitted by the base station and/or the other terminal.

The methods according to the embodiments described in the claims or the detailed description of the present disclosure may be implemented in hardware, software, or a combination of hardware and software.

The programs (e.g., software modules or software) may be stored in random access memory (RAM), non-volatile memory including flash memory, read-only memory (ROM), electrically erasable programmable read-only memory (EEPROM), a magnetic disc storage device, compact disc-ROM (CD-ROM), a digital versatile disc (DVD), another type of optical storage device, or a magnetic cassette. Alternatively, the programs may be stored in a memory system including a combination of some or all of the above-mentioned memory devices. In addition, each memory device may be included by a plural number.

The programs may also be stored in an attachable storage device which is accessible through a communication network such as the Internet, an intranet, a local area network (LAN), a wireless LAN (WLAN), or a storage area network (SAN), or a combination thereof. The storage device may be connected through an external port to an apparatus according the embodiments of the present disclosure. Another storage device on the communication network may also be connected to the apparatus performing the embodiments of the present disclosure.

Those skilled in the art will understand that the above illustrative embodiments are described herein and are not intended to be limiting. It should be understood that any two or more of the embodiments disclosed herein may be combined in any combination. Furthermore, other embodiments may be utilized and other changes may be made without departing from the spirit and scope of the subject matter presented herein. It will be readily understood that aspects of the disclosure of the disclosure as generally described herein and shown in the drawings may be arranged, replaced, combined, separated and designed in various different configurations, all of which are contemplated herein.

Those skilled in the art will understand that the various illustrative logical blocks, modules, circuits, and steps described in this application may be implemented as hardware, software, or a combination of both. To clearly illustrate this interchangeability between hardware and software, various illustrative components, blocks, modules, circuits, and steps are generally described above in the form of their functional sets. Whether such function sets are implemented as hardware or software depends on the specific application and the design constraints imposed on the overall system. Technicians may implement the described functional sets in different ways for each specific application, but such design decisions should not be interpreted as causing a departure from the scope of this application.

The various illustrative logic blocks, modules, and circuits described in this application may be implemented or performed by a general purpose processor, a digital signal processor (DSP), an application specific integrated circuit (ASIC), a field programmable gate array (FPGA) or other programmable logic devices, discrete gates or transistor logics, discrete hardware components, or any combination thereof designed to perform the functions described herein. The general purpose processor may be a microprocessor, but in an alternative, the processor may be any conventional processor, controller, microcontroller, or state machine. The processor may also be implemented as a combination of computing devices, such as a combination of a DSP and a microprocessor, a plurality of microprocessors, one or more microprocessors cooperating with a DSP core, or any other such configuration.

When the electrical structures and methods are implemented in software, a computer-readable recording medium having one or more programs (software modules) recorded thereon may be provided. The one or more programs recorded on the computer-readable recording medium are configured to be executable by one or more processors in an electronic device. The one or more programs include instructions to execute the methods according to the embodiments described in the claims or the detailed description of the present disclosure.

In the afore-described embodiments of the present disclosure, elements included in the present disclosure are expressed in a singular or plural form according to the embodiments. However, the singular or plural form is appropriately selected for convenience of explanation and the present disclosure is not limited thereto. As such, an element expressed in a plural form may also be configured as a single element, and an element expressed in a singular form may also be configured as plural elements.

The embodiments disclosed herein can be implemented using at least one hardware device and performing network management functions to control the elements.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE) in a wireless communication system, the method comprising:
receiving satellite coverage availability information;
identifying, based on the satellite coverage availability information, a coverage for a satellite communication at a location and a time is available or not;
identifying, information on at least one or more public land mobile networks (PLMNs) at a present location of the UE; and
performing, a communication based on the information on the at least one or more PLMNs.

2. The method of claim 1, wherein the satellite coverage availability information is received from a network entity via at least one of a protocol data unit (PDU) session or a short message service (SMS).

3. The method of claim 1, wherein the satellite coverage availability information includes a cause indicating that a PLMN is not allowed to operate at the present location of the UE.

4. The method of claim 1, wherein the satellite coverage availability information includes subset area information including at least one of allowed PLMN identifiers (IDs) or not allowed PLMN IDs at the present location of the UE.

5. The method of claim 2, wherein the network entity comprises at least one of a satellite coverage availability function (SCAF) entity, an access and mobility management function (AMF) entity, or an external server.

6. A method performed by a network entity in a wireless communication system, the method comprising:
transmitting, to a user equipment (UE), satellite coverage availability information;
identifying, based on the satellite coverage availability information, a coverage for a satellite communication at a location and a time is available or not;
identifying, information on at least one or more public land mobile networks (PLMNs) at a present location of the UE; and
performing, a communication based on the information on the at least one or more PLMNs.

7. The method of claim 6, wherein the satellite coverage availability information is received from the network entity via at least one of a protocol data unit (PDU) session or a short message service (SMS).

8. The method of claim 6, wherein the satellite coverage availability information includes a cause indicating that a PLMN is not allowed to operate at the present location of the UE.

9. The method of claim 6, wherein the satellite coverage availability information includes a subset area information including at least one of allowed PLMN identifiers (IDs) or not allowed PLMN IDs at a present location of the UE.

10. The method of claim 6, wherein the network entity comprises at least one of a satellite coverage availability function (SCAF) entity, an access and mobility management function (AMF) entity or an external server.

11. A user equipment (UE) in a wireless communication system, the UE comprising:
a transceiver; and
a controller coupled to the transceiver; the controller configured to:
receive satellite coverage availability information,
identify, based on the satellite coverage availability information, a coverage for a satellite communication at a location and a time is available or not,
identify information on at least one or more public land mobile networks (PLMNs) at a present location of the UE, and
perform a communication based on the information on the at least one or more PLMNs.

12. The UE of claim 11, wherein the satellite coverage availability information is received from a network entity via at least one of a protocol data unit (PDU) session or a short message service (SMS).

13. The UE of claim 11, wherein the satellite coverage availability information includes a cause indicating that a PLMN is not allowed to operate at the present location of the UE.

14. The UE of claim 11, wherein the satellite coverage availability information includes a subset area information including at least one of allowed PLMN identifiers (IDs) or not allowed PLMN IDs at the present location of the UE.

15. The UE of claim 12, wherein the network entity comprises at least one of a satellite coverage availability function (SCAF) entity, an access and mobility management function (AMF) entity or an external server.

16. A network entity in a wireless communication system, the network entity comprising:
a transceiver; and
a controller coupled to transceiver, the controller configured to:
transmit, to a user equipment (UE), satellite coverage availability information,
identify, based on the satellite coverage availability information, a coverage for a satellite communication at a location and a time is available or not,
identify, information on at least one or more public land mobile networks (PLMNs) at a present location of the UE, and
perform, a communication based on the information on the at least one or more PLMNs.

17. The network entity of claim 16, wherein the satellite coverage availability information is received from the network entity via at least one of a protocol data unit (PDU) session or a short message service (SMS).

18. The network entity of claim 16, wherein the satellite coverage availability information includes a cause indicating that a PLMN is not allowed to operate at a present location of the UE.

19. The network entity of claim 16, wherein the satellite coverage availability information includes a subset area information including at least one of allowed PLMN identifiers (IDs) or not allowed PLMN IDs at a present location of the UE.

20. The network entity of claim 16, wherein the network entity comprises at least one of a satellite coverage availability function (SCAF) entity, an access and mobility management function (AMF) entity or an external server.
